(19) United States
(12) Patent Application Publication
(10) Pub. No.: US 2009/0195089 A1
(43) Pub. Date: Aug. 6, 2009

(54) Mover of a Linear Motor with an Outer Heat Radiating Housing

(76) Inventors: Lieh-Feng HUANG, Taichung (TW); Fang-Fang Tai, Taichung (TW)

Correspondence Address: Dr. BANGER SHIA, 102 Lindencrest Ct., Sugar Land, TX, 77479-5201, US

(21) Appl. No.: 12/024,095

(22) Filed: Jan. 31, 2008

(51) Int. Cl. H02K 9/22; H02K 41/02; H02K 5/04

(52) U.S. Cl. 310/12.29

(57) ABSTRACT

A mover of a linear motor with an outer heat radiating housing comprises a body and an outer heat radiating housing. The body includes an iron core and coils. The outer heat radiating housing covers the body and is integrally jointed to the body. The outer heat radiating housing is defined with a plurality of passages. When the current is supplied to the coils of the body, the body will be driven, the heat energy produced by the body can be conducted to the outer heat radiating housing sufficiently. In addition, after the cooling liquid is conducted to the passages, the heat radiating effect of the mover can be improved.

### BACKGROUND OF THE INVENTION

1. Field of the Invention

The present invention relates to a linear electric propulsion system, and more particularly to a mover of a linear motor with an outer heat radiating housing.

2. Description of the Prior Art

The technology of linear motors is such that the N poles and S poles are alternatively arranged in a line to serve as a stator, and the current direction of coils in a mover is changeable to control the magnetic direction of the mover, such that the magnetic fields of the mover and the stator will be changed to achieve the objective of linear displacement. The mover can drive a machine or an apparatus to move linearly simply by disposing the machine or the apparatus on the mover, so as to achieve the objective of moving the machine or the apparatus.

Referring to FIG. 1, since it will produce heat energy during movement, the mover A is defined with a passage (not shown) for enabling the cooling liquid to flow into an inlet A1 and out of an outlet A2 of the passage, and enabling the heat energy of the mover A to guide out of the passage after being conducted to the cooling liquid. In order to improve the heat radiating effect, the mover A is disposed with a radiator B, and a layer of heat radiating grease C is coated between the mover A and the radiator B, such that the heat energy of the mover A will be conducted to the radiator B via the heat radiating grease C, and then will be discharged by the radiator B.

The heat radiating methods of the radiator B are various, and the current technologies are: an air-cooled method for lowering the temperature by air, or a water-cooled method for lowering the temperature of the liquid by defining the passage (not shown), the inlet B1 and the outlet B2 in the radiator B as shown in FIG. 1, or disposing a plurality of fins or fans on the radiator B. All these equipments are assembled on the mover A additionally, so the radiator B are not in close contact with the mover A, and an actual contacting area of the radiator B and the mover A is much smaller than an area of the mover A covered by the radiator B. As a result, the heat conducting effect will not be good and the heat radiating effect is limited. When the mover A is carried with a precise temperature control apparatus, the quality of the products to be processed will not be good and the products are likely to be damaged due to one or two degrees temperature increase of the mover A.

Further, if the heat radiating grease C is coated unevenly, the temperature conducted to the radiator B by the mover A will uneven, such that the temperature of part of the mover A will be relatively high. Similarly, the quality of the products to be processed by the machine disposed on the mover A will not be good and the products are likely to be damaged.

The present invention has arisen to mitigate and/or obviate the afore-described disadvantages.

### SUMMARY OF THE INVENTION

The primary objective of the present invention is to provide a mover of a linear motor with an outer heat radiating housing which joints an outer heat radiating housing to a body to improve the heat conducting effect between the body and the outer heat radiating housing, such that the heat radiating effect is improved and the heat can be radiated more evenly.

To achieve the objective of the present invention, the mover includes a body and an outer heat radiating housing. Coils are disposed in the body. The outer heat radiating housing covers the body and is integrally jointed to the body.

When current is supplied to the coils to make the mover move on the stator, since the outer heat radiating housing is integrally jointed to the body, the heat conducting effect is quite good, and the heat energy produced by the body can be conducted to the outer heat radiating housing evenly and sufficiently.

In addition, the outer heat radiating housing can be defined with a plurality of passages, and cooling liquid can be guided to the passages, thus improving the heat radiating effect of the outer heat radiating housing.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is an illustrative view showing a conventional mover being assembled with a radiator;

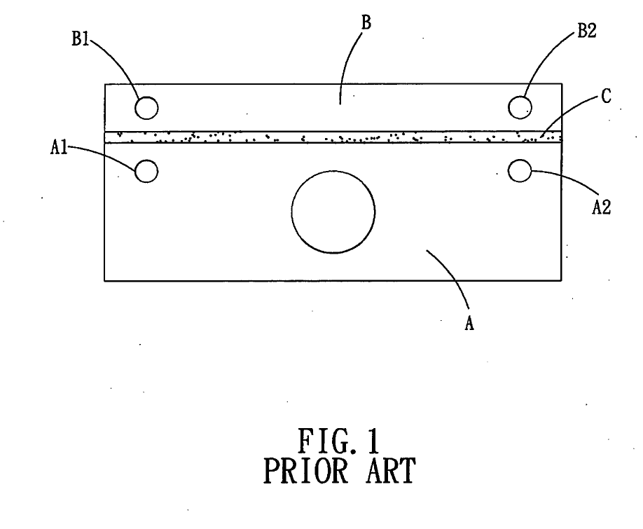

FIG. 2 is an illustrative view showing an outer heat radiating housing being defined with passages in accordance with the present invention;

FIG. 3 is an illustrative view showing the passages being closed by screws in accordance with the present invention; and

FIG. 4 is a perspective view of a mover of a linear motor with an outer heat radiating housing in accordance with the present invention.

### DETAILED DESCRIPTION OF THE PREFERRED EMBODIMENTS

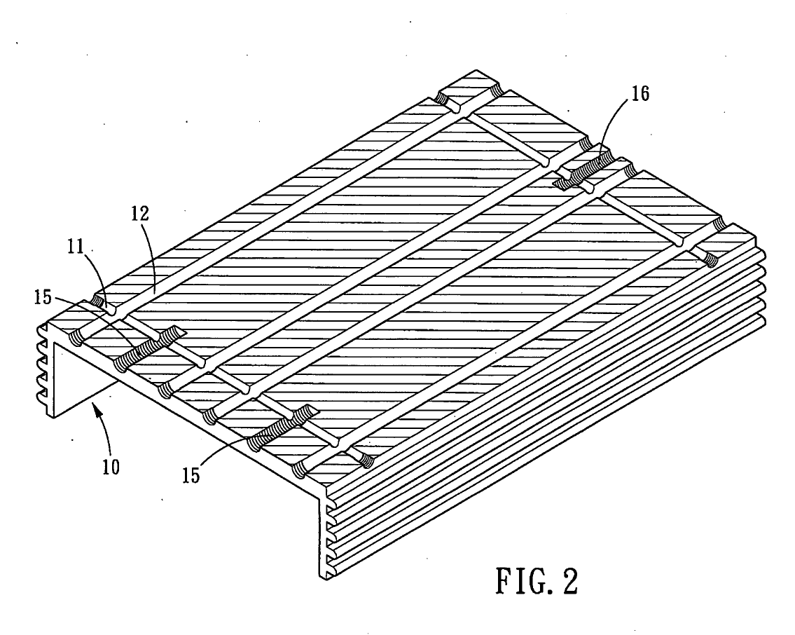

Referring to FIGS. 2-4, a mover of a linear motor with an outer heat radiating housing in accordance with the present invention comprises an outer heat outer heat radiating housing 10 and a body 20.

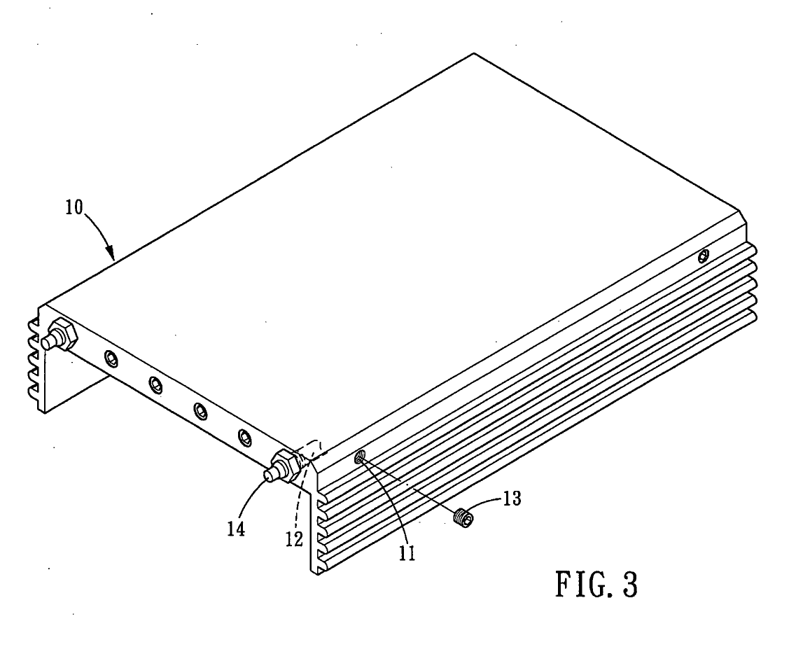

Referring to FIG. 2, the outer heat radiating housing 10 is made by press forming of aluminum material and is defined with two transverse passages 11 and four longitudinal passages 12 that are intersected and in communication with one another. Referring to FIG. 3, both ends of each transverse passage 11 are closed by screws 13, and both ends of two of the longitudinal passages 12 are closed by the screws 13, respectively. Each of the other two longitudinal passages 12 has one end disposed with a guiding member 14 and has the other end sealed with a screw 13. The guiding members 14 are provided for guiding the liquid into and out of the transverse and the longitudinal passages 11, 12, respectively. One of the transverse passages 11 is longitudinally defined with two through holes 15 that are in communication with the outside. At each side of the outer heat radiating housing 10 is arranged two longitudinal passages 12 in such a manner that one of the through holes 15 is located between the two longitudinal passages 12 at one side of the outer heat radiating housing 10, and the other through hole 15 is located between the other two longitudinal passages 12 at the other side of the outer heat radiating housing 10. The other transverse passage 11 is longitudinally defined with a through hole 16 that is in communication with the outside and is located between the middle two of the longitudinal passages 12. The through holes 15 are closed by the screws 13 to cut off one transverse passage 11, and the through hole 16 is closed by the screw 13 to cut off the other transverse passage 11.

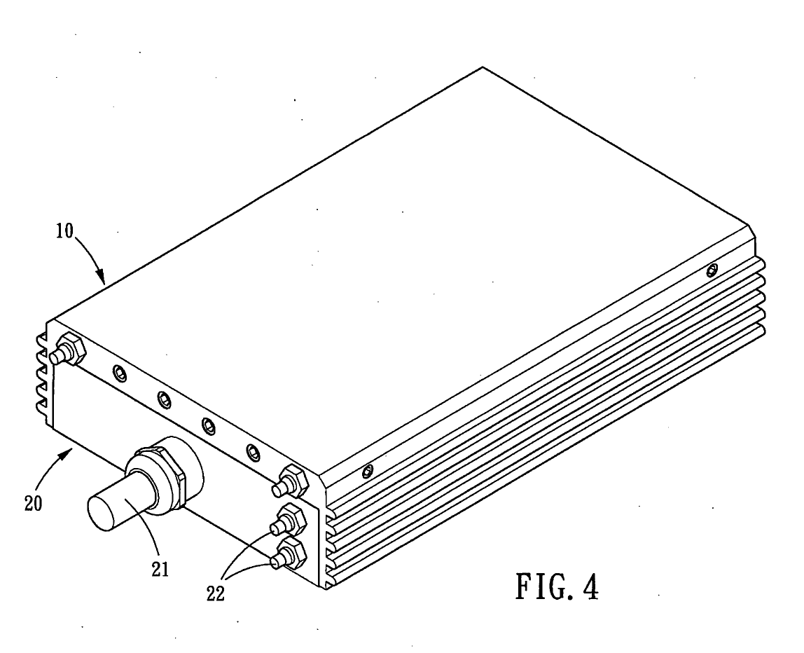

The body 20 includes an iron core (not shown) wound by coils (not shown), a control cable 21 and a passage (not shown). The iron core is located in the body 20. The control cable 21 is connected to the iron core and extends outward from the body 20. The passage is located in the body 20, and at each of an inlet and an outlet of the passage are disposed a guiding member 22 for guiding liquid into and out of the body 20. The outer heat radiating housing 10 covers the body 20 and is integrally jointed to the body 20 as shown in FIG. 4.

During the manufacturing of the mover, the outer heat radiating housing 10 is first made by press forming of aluminum material, then the passages 11, 12 and the through holes 15, 16 are drilled in the passages 11, 12, the screws 13 and the guiding members 14 are disposed in the passages 11, 12 and the through holes 15, 16. Thereafter, the iron core is connected to the control cable 21, and then they are assembled to the outer heat radiating housing 10. After that, adhesive is injected into the outer heat radiating housing 10 to the body 20 after it is cooled down and solidified. Finally, the body 20 is processed to form the passage in an outer surface thereof, and at each of the inlet and the outlet of the passage of the body 20 is disposed the guiding member 22.

Since the body 20 is directly formed by adhesive injection into the outer heat radiating housing 10 and is combined with the iron core and the control cable 21, the body 20 is integrally jointed to the outer heat radiating housing 10. Thereby, an actual contacting area of the outer heat radiating housing 10 and the body 20 is nearly equal to an area of the body 20 covered by the outer heat radiating housing 10. The bigger the contacting area is, the better heat conducting effect between the body 20 and the outer heat radiating housing 10 will be, such that the heat energy produced by the body 20 can be sufficiently conducted to the outer heat radiating housing 10 and radiated to the outside.

Since the body 20 is integrally jointed to the outer heat radiating housing 10, the heat energy produced by each portion of the body 20 can be conducted to the outer heat radiating housing 10, such that the heat energy produced by the body 20 can be radiated more evenly.

In addition, since the body is directly formed by adhesive injection into the outer heat radiating housing 10, that is, the outer heat radiating housing 10 is directly used as a mould, a demoulding process is omitted. To the contry, in the prior art, the mover A and the radiator B are made separately, so the demoulding process must be firstly performed during the manufacturing of the mover A, and then the radiator B is disposed, which is quite complex. Thereby, the present invention has a simple manufacturing process, and is timesaving and laborsaving, and can improve the productivity. Further, since the demoulding process is omitted, the damage caused by the demoulding process is reduced and the quality of the products is improved.

While we have shown and described various embodiments in accordance with the present invention, it should be clear to those skilled in the art that further embodiments may be made without departing from the scope of the present invention.

What is claimed is:

1. A mover of a linear motor with an outer heat radiating housing, comprising:
a body having an iron core wound by coils and a control cable, the control cable being connected to the iron core and extending outward from the body; and
an outer heat radiating housing covering the body and being integrally jointed to the body.

2. The mover of a linear motor with an outer heat radiating housing as claimed in claim 1, wherein the outer heat radiating housing is defined with a plurality of passages.

3. The mover of a linear motor with an outer heat radiating housing as claimed in claim 2, wherein the passages are intersected and in communication with one another.

4. The mover of a linear motor with an outer heat radiating housing as claimed in claim 2, wherein each of two of the passages of the outer heat radiating housing has one end disposed with a guiding member and has the other end sealed with a screw, and both ends of other passages of the outer heat radiating housing are closed by screws, respectively.

5. The mover of a linear motor with an outer heat radiating housing as claimed in claim 1, wherein a passage is defined in the body.
